(19) United States
(12) Patent Application Publication
(10) Pub. No.: US 2010/0228601 A1
(43) Pub. Date: Sep. 9, 2010

(54) Method and System of Applying Environmental Incentives

(75) Inventors: Raj Vaswani, Portola Valley, CA (US); Sean M. Fitzgerald, Chonburi (TH)

Correspondence Address: BUCHANAN, INGERSOLL & ROONEY PC, POST OFFICE BOX 1404, ALEXANDRIA, VA, 22313-1404, US

(73) Assignee: SILVER SPRING NETWORKS, INC., Redwood City, CA (US)

(21) Appl. No.: 12/571,803

(22) Filed: Oct. 1, 2009

Related U.S. Application Data
(60) Provisional application No. 61/101,929, filed on Oct. 1, 2008.

(51) Int. Cl. G06Q 99/00; G06Q 10/00; G06Q 30/00; G06Q 40/00; G06Q 50/00; G08C 15/06; G06F 1/26; G01R 13/04

(52) U.S. Cl. 705/10; 705/30; 705/34; 705/35; 705/37; 705/317; 340/870.02; 700/295; 324/113

(57) ABSTRACT

Information relating to electrical energy usage for a given account is associated with a time segment that corresponds to a period when the electrical energy was received from an electrical energy distribution system. Electrical energy generation carbon impact information is retrieved for the corresponding time segment specifying when the electrical energy was received from an electrical energy distribution system. A carbon credit is calculated according to the retrieved electrical energy generation carbon impact information, and the retrieved electrical energy usage information associated with the time segment. The calculated carbon credit is then used to update a display of carbon credit related information, such as account balance, rate of carbon credit usage, currently applicable “cost” for carbon credit usage. Notifications can be provided to the consumer if any of this information crosses a threshold value. In addition, or alternatively, the carbon credit related information can be used to automatically control the operation of devices that consume electrical energy.

### BACKGROUND

As technological advances continue, and the standards of living among the world's populations grow, the demand for energy to support such growth rises at an ever-increasing rate. The production and utilization of vast quantities of energy, in various forms, is known to have an adverse effect on the quality of the Earth's overall environment, as well as more pronounced influences in localized areas where such production and/or utilization occur. For instance, the burning of coal to produce electricity, and the combustion of petroleum products to power vehicles and other machinery, emit noxious gases that can be harmful to living organisms. Other gases that are byproducts of energy generation and utilization, sometimes referred to as “greenhouse gases”, may not be toxic, but could still have an adverse effect on the environment. One well known effect is the role that carbon dioxide emissions have on the Earth's ozone layer, and the resulting contribution to global warming.

In an effort to combat the negative consequences resulting from energy utilization, various incentives have been developed to limit the amount of energy that any particular entity can consume. One such type of incentive is known as a “carbon credit”. In essence, an entity such as a manufacturing plant is issued a number of carbon credits that are based upon an amount of energy consumption by that entity, or resulting emissions from such consumption, that is considered to be acceptable. If the entity needs to consume more energy than the amount corresponding to its allotted carbon credits without incurring a penalty, it must acquire additional credits. Conversely, if the entity does not need to use all of its allotted credits, it can transfer them to another entity who is in need of additional credits.

To date, the deployment of environmental incentives, such as carbon credits, has been limited in scope, primarily in connection with larger entities such as manufacturing facilities and the like, which are consumers of massive amounts of energy and/or producers of significant emissions that adversely affect the environment. It is desirable to deploy environmental incentives on a wider scale, so that they can be applied to all types of consumers and producers of energy.

On a more global basis, it is desirable to develop a mechanism for applying incentives to any type of activity where the true cost of such activity is not exposed. Examples of such include the utilization of scarce or limited resources, such as water, or the trading of controversial goods, e.g. conflict diamonds.

### SUMMARY OF THE INVENTION

In an exemplary embodiment relating to electrical energy consumption, information relating to electrical energy usage for a given account is associated with a time segment that corresponds to a period when the electrical energy was received from an electrical energy distribution system. Electrical energy generation carbon impact information is retrieved for the corresponding time segment specifying when the electrical energy was received from an electrical energy distribution system. The electrical energy generation carbon impact information indicates carbon released to generate the electrical energy during the corresponding time segment. A carbon credit is calculated according to the retrieved electrical energy generation carbon impact information, and the retrieved electrical energy usage information associated with the time segment. The calculated carbon credit is then used to update a display of carbon credit related information, such as account balance, rate of carbon credit usage, currently applicable “cost” for carbon credit usage, or the like. Notifications can be provided to the consumer if any of this information crosses a threshold value. In addition, or alternatively, the carbon credit related information can be used to automatically control the operation of devices that consume electrical energy.

The carbon related scenario described above is exemplary; the overall system and approach described herein is directly applicable to the measurement and impact tracking of other materials or consequences directly or indirectly related to energy generation, transmission or consumption (e.g., “sulfur dioxide credits”, “nuclear waste material credits”, “transmission line radio frequency emissions credits”, “trees removed due to power plant construction debits” and so on).

### BRIEF DESCRIPTION OF THE DRAWINGS

FIG. 1 is a generalized block diagram of a utility network, according to one possible embodiment.

FIG. 2 is a generalized block diagram of a utility grid and related entities, according to one possible embodiment.

FIG. 3-A is a generalized block diagram of a smart grid data management system, according to one possible embodiment.

FIG. 3-B is a generalized block diagram of a smart grid data management system, according to another possible embodiment.

FIG. 3-C is a generalized block diagram of a smart grid data management system, according to a further possible embodiment.

FIG. 3-D is a generalized block diagram of a smart grid data management system interoperating with smart grid data management systems from other utilities, according to yet another possible embodiment.

FIG. 4 is a flow chart of a process for associating usage data and generation data for incentive calculations, according to one possible embodiment.

FIG. 5-A is a generalized block diagram of a display on a thermostat for displaying incentive information, according to one possible embodiment.

FIG. 5-B is a generalized block diagram of a display for displaying incentive information, according to another possible embodiment.

FIG. 5-C is a generalized block diagram of a display for displaying incentive information in a vehicle, according to one possible embodiment.

FIG. 6 is a generalized block diagram of a display interacting with other devices, according to one possible embodiment.

FIG. 7 is a flow chart of a process for updating and communicating with a display, according to one possible embodiment.

### DETAILED DESCRIPTION OF ILLUSTRATIVE EMBODIMENTS

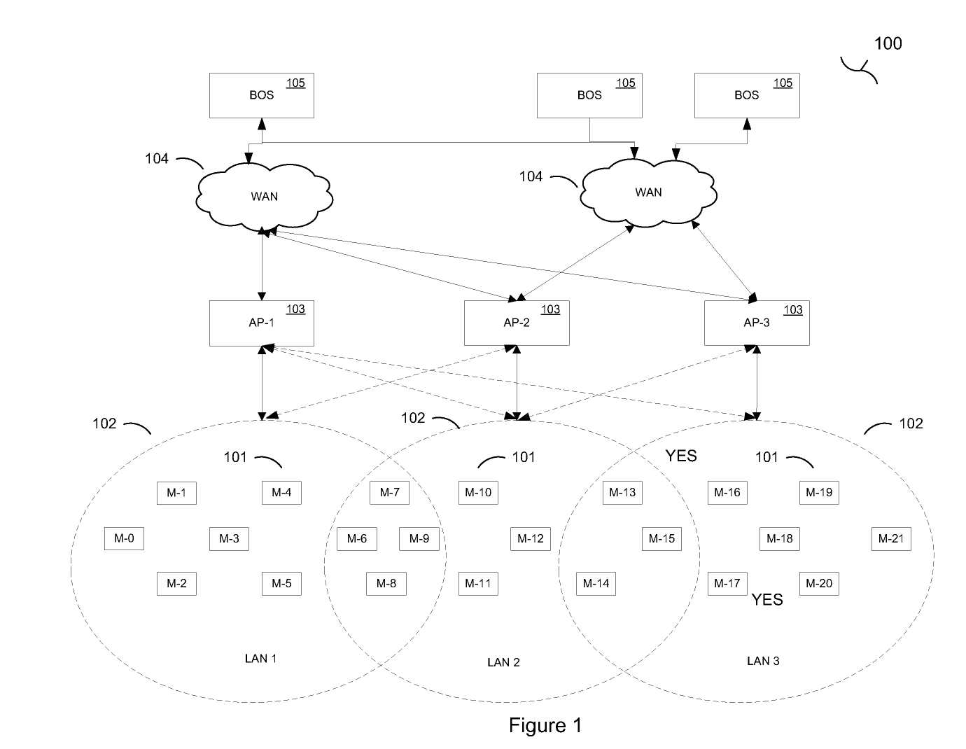

FIG. 1 is a generalized block diagram of a utility network 100 that may be used to implement embodiments of the present invention. Utility network 100 may include one or more electronic devices 101. In a preferred embodiment, the electronic devices 101 may be connected over a wireless local area network (LAN) 102. In the example of a utility network, the LAN may be a neighborhood area network (NAN) corresponding to a neighborhood or service area for the utility. As shown in the example embodiment, multiple LANs may be used, which may or may not overlap, such that a given electronic device can be connected to (or be part of) only one wireless LAN or multiple wireless LANs. The electronic devices may be any type of electronic device. Examples of electronic devices include utility nodes, which may include a utility meter or may connect to a utility meter. A utility meter is a device that is capable of measuring a metered quantity, typically a commodity such as electricity, water, natural gas, etc. Utility nodes that connect to a utility meter may include a network interface card (NIC) for communicating on a network, and may include one or more RF transceivers for communicating on one or more wireless LANs. Other examples of electronic devices include communication devices, such as set top boxes (as may be used in cable television or satellite television delivery), household appliances (e.g. refrigerator, heater, light(s), cooking appliances, etc.), computers or computing devices (e.g., storage devices, PCs, servers, etc.) networking devices such as relays, gateways, access points, routers, or other such devices, phones or cell phones, battery storage devices, transportation devices, transportation vehicles (for example: an electric or hybrid car or other vehicle), entertainment devices (e.g. TVs, DVD players, gaming consoles, etc.), or other devices which may be found in a home, business, roadway or parking lot, or other location. Relays may handle communication between electronic devices 101 and the wireless LAN 102. For example, a relay could provide communication between the electronic device and the infrastructure of the wireless network. Unless otherwise noted, other devices in the network such as meters, electronic devices, etc. may also function as relays, and relays may perform the functions of other devices or software on the network. The wireless LAN 102 may be any type of wireless network, and may use any frequency, communications channel or communications protocol.

Of course, the LAN 102 could also be partially or totally wired. For instance, in the case of an electric power distribution network, the LAN could be implemented by means of power line communications (PLC), twisted pair copper, fiber optic, etc. Any other suitable hard-wired networking technology can likewise be employed. The various technologies may be employed for the entire network uniformly, or particular technologies may be employed in particular areas of the network, or multiple technologies may be employed simultaneously at any point in the network. To support this flexibility, the NIC used for communications may contain support for more than one technology (e.g., an RF transceiver for wireless communications combined with a PLC transceiver, RF and PLC transceivers combined with an Ethernet transceiver for twisted pair copper, or any combination necessary to support the multiple communications transport options).

The LANs 102 are typically connected to one or more access points (AP) 103. A given LAN may be connected to only a single AP, or may be connected to two or more access points. The access points 103 may be connected to one or more wide area networks (WAN) 104. The WANs 104 may be connected to one or more back office systems (BOS) 105. The back office system may handle a variety of business or management tasks, including participation in the collection of metering information, managing metering devices, security for the network, or other functions as may be desired in an advanced metering infrastructure (AMI) network. Examples of back office systems include billing and accounting systems, proxy servers, outage detection systems (as may be used in a utility network), data storage systems, etc.

Nodes within the communications network, which may be a LAN or a WAN, or a combination of both, may communicate using one or more proprietary and/or publicly available protocols. Nodes may include an electronic device, a relay, an access point, a router, or a BOS. In the case of publicly available protocols, some nodes may be able to communicate using IPv6, for instance, some may be capable of communicating on IPv4, while some may be capable of communicating on either IPv4 or IPv6. Some nodes may be capable of encapsulating IPv6 packets in an IPv4 packet. Additionally, some nodes may be able to establish an IPv4 tunnel through an IPv6 network. The communication between nodes is described more fully below.

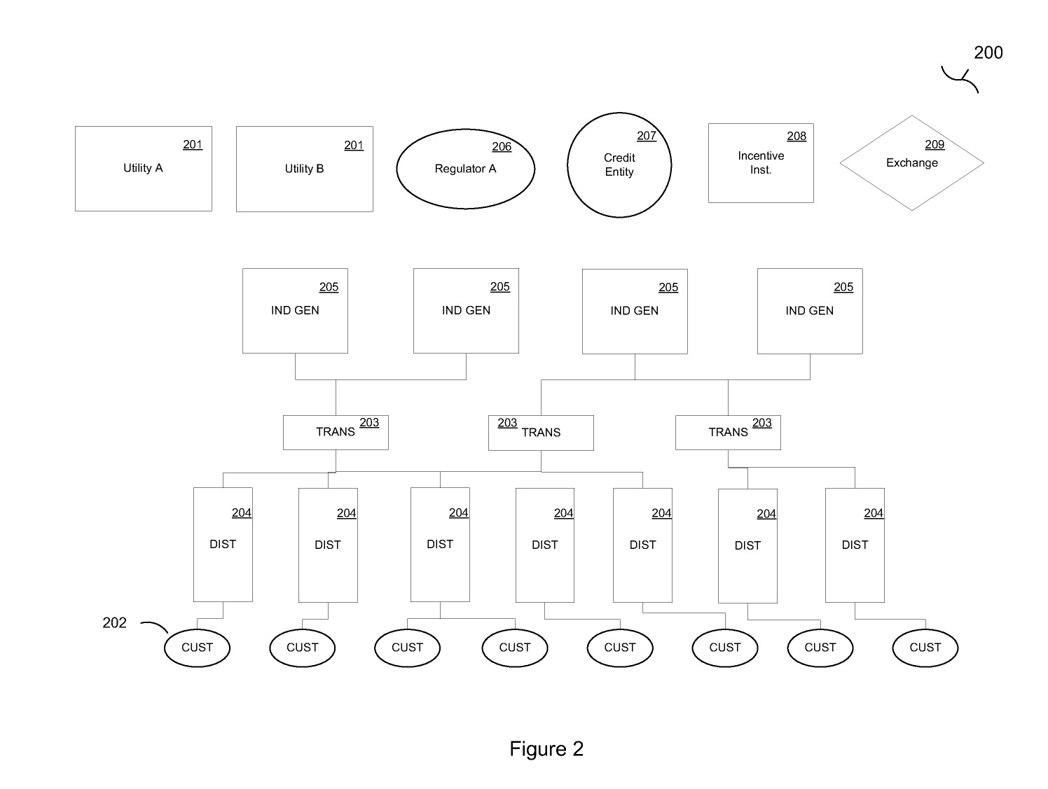

FIG. 2 is a generalized block diagram of a utility grid 200 where electric utilities 201 supply electricity to their customers 202 through transmission lines 203 and/or distribution systems 204. The electric utilities 201 may have their own sources of generation (not shown) or they may use generation from other utilities or from independent generators 205. The market for electricity, as supplied to the utilities, may be regulated or managed by one or more regulating entities (such as an Independent System Operator (ISO)0 206. Typically, utilities are responsible for the metering and billing of their customers, but these services may be performed in conjunction, or on their behalf, with other entities. Incentives, such as carbon credits, may be calculated and allocated by the utility or by a separate credit allocation entity 207. Incentives may be allocated to customer accounts at the utility, or in separate incentive accounts at incentive institutions 208 (for example, a brokerage may allow for accounts in incentives such as carbon credits, and may allow for account holders to buy, sell, trade, or use other services available for financial instruments). Incentive institutions 208 may also hold credit accounts for other entities, such as the utilities, independent generators, owners of infrastructure such as transmission lines, or any other person or entity. Incentives may be traded on an exchange 209, such as a carbon credit exchange, futures or options exchanges, or any other type of exchange.

### Smart Grid

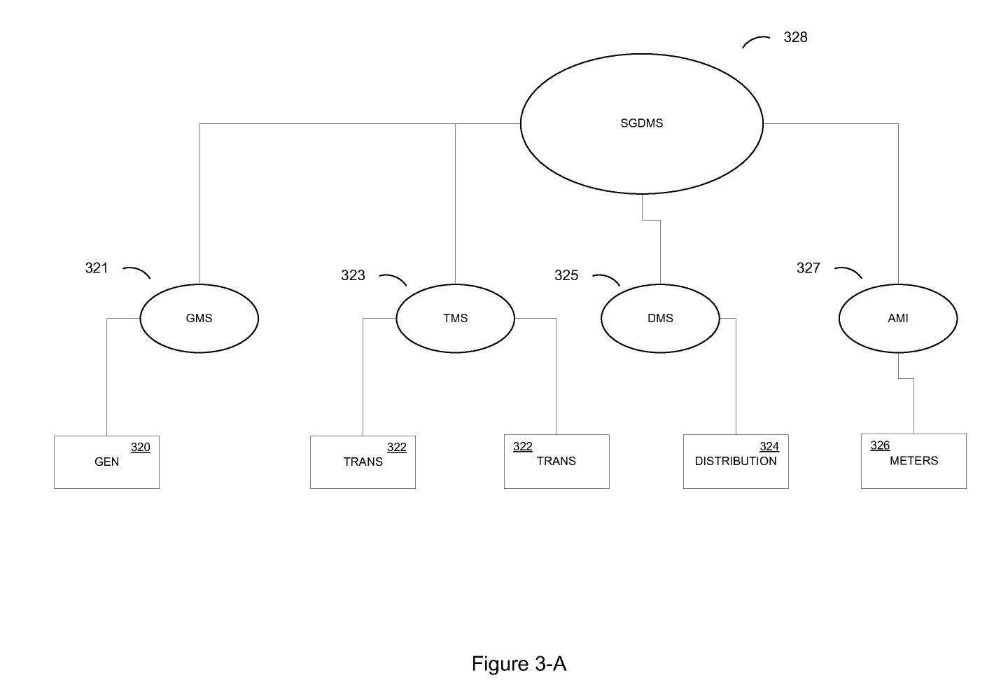

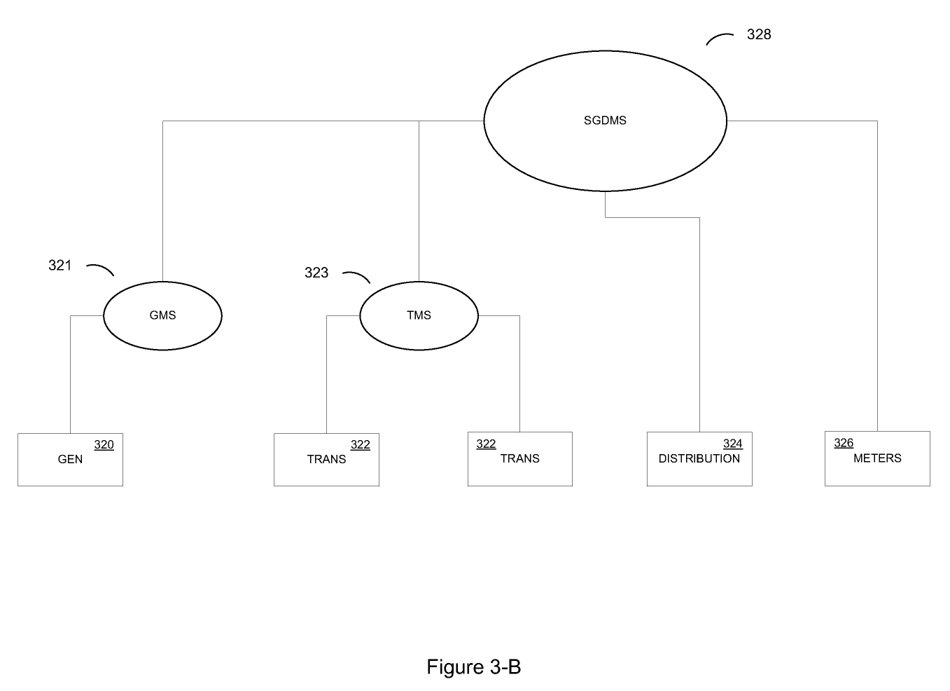

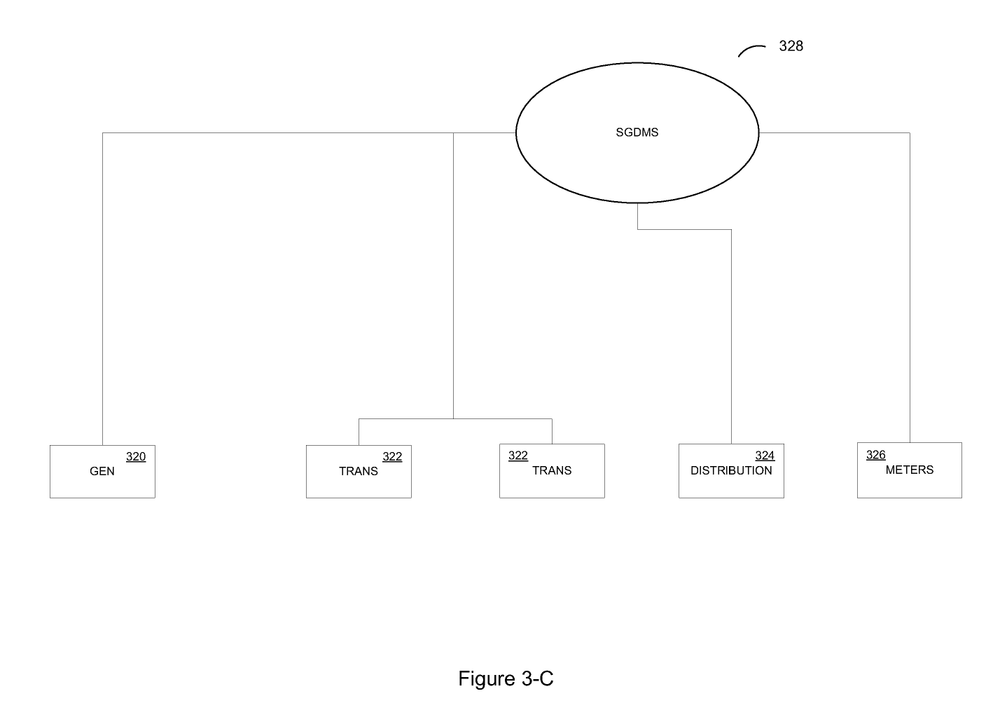

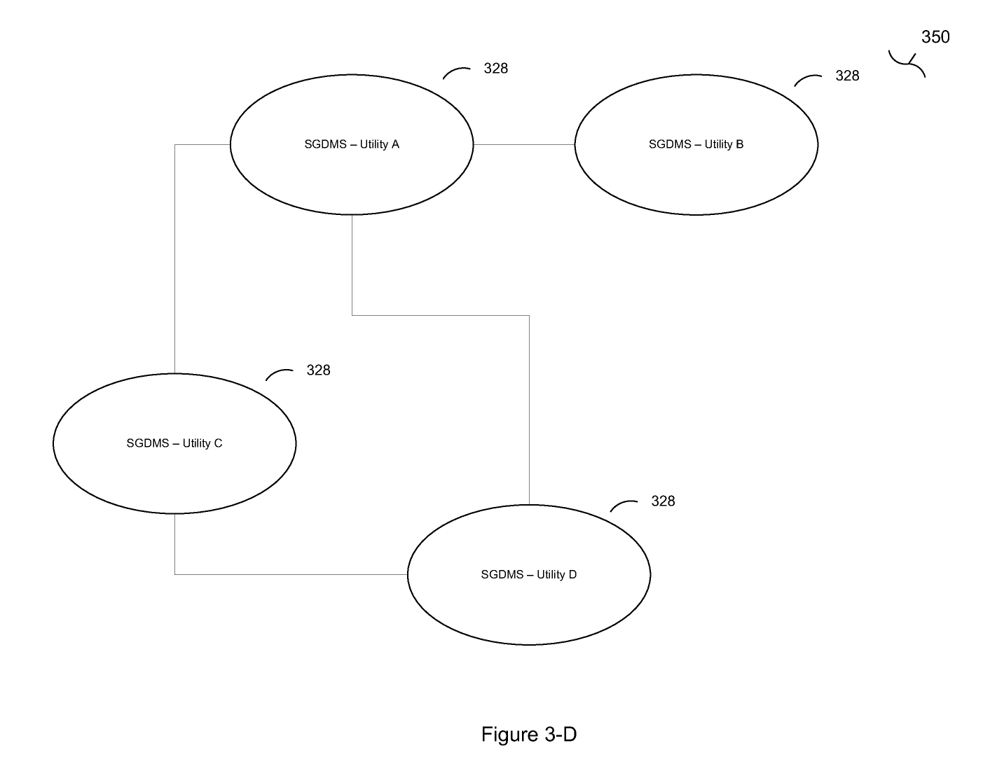

FIG. 3-A is a generalized block diagram of software and information components of a utility grid. Generation facility 320 has at least one generation management system 321, the generation management system managing at least a portion of the generation facility (or facilities). Examples of generation facilities include a coal-fired power plant, a gas-fired power plant, a nuclear power plant, a solar electrical generation facility, a wind turbine facility, etc. The generation facility provides power to at least one transmission facility 322, such as high voltage transmission lines. Transmission facility 322 has at least one transmission management system 323, the transmission management system managing at least a portion of the transmission facility (or facilities).

The transmission facility 322 supplies the power to at least one distribution system 324 which distributes electrical energy to residential, commercial and/or government customers of the electrical utility. Distribution system 324 may include substations, transformers, local transmission lines, capacitor banks, and any other systems or equipment used to deliver power to the customers of a utility. Distribution system 324 has at least one distribution management system 325, the distribution management system managing at least a portion of the distribution system (or systems). Electrical energy meters (or electrical energy metering and/or monitoring system or systems) 326 are connected to an electrical meter management system 327 (such as an AMI network management system).

The AMI management system 327, distribution management system 325, transmission management system 323 and generation management system 321 may connect to a smart grid management system 328. The grid management system 328, or smart grid data management system, may allow the various AMI management system 327, distribution management system 325, transmission management system 323 and generation management system 321 to exchange information, coordinate their various activities, and connect with other systems used by the utility, its customers, its partners (such as accounting systems, ERP systems, reporting systems, etc,), and/or other third parties, and may also provide access (partial or complete) of data available to such systems to the utility, its employees, its customers, and/or its partners.

FIG. 3-B is a generalized block diagram of a utility grid illustrating an alternate embodiment of software and information components. Distribution system 324 and electrical energy meters (or electrical energy metering and/or monitoring system or systems) 326 connect to grid management system 328 which performs some or all of the functions of an AMI management system and/or distribution system management system.

FIG. 3-C is a generalized block diagram of a utility grid illustrating an alternate embodiment of software and information components. Generation facility 320, transmission facility 322, distribution system 324 and electrical energy meters (or electrical energy metering and/or monitoring system or systems) 326 connect to grid management system 328 which performs some or all of the functions of an AMI management system, transmission management system, generation management system and/or distribution system management system. In the event one or more management systems are not implemented by the grid management system, a separate management system may also exist and communicate with both the grid management system and one or more facilities.

FIG. 3-D is a generalized block diagram of a network 350 of smart-grid data management systems. The grid management systems 328 associated with a given utility connect to one or more grid management systems associated with other utilities. As shown, the grid management system associated with utility A connects to the grid management systems associated with utilities B, C and D, whereas the grid management system associated with utility B directly connects only to the grid management system associated with utility A. The grid management system associated with utility A may connect the grid management system associated with utility B to the grid management system associated with utilities C and/or D, or may provide data from the grid management system associated with utilities C and/or D to the grid management system associated with utility B, or may not provide access or data from the grid management system associated with utilities C and/or D to grid management system associated with utility B. The grid management system of a given utility may control which grid management systems of other utilities may receive data from that system, even if the data from the given grid management system is passed through one or more intermediary grid management systems from other utilities. For example, grid management system associated with utility B may allow generation and transmission data to be provided from the grid management system associated with utility A to the grid management system associated with utility C but not the grid management system associated with utility D, while only the grid management system associated with utility A may receive some of the AMI data from the grid management system associated with utility B. Access to data may further be restricted by users within utilities, departments or units within a utility (however such a unit may be organized or separated from other functions or parts of a utility, and whether the unit includes employees, customers, partners, regulators or others, or some combination thereof), by time, authorization or approval ticket, condition (such as an emergency, audit condition or mode, etc.), etc.

Such a network of grid data management systems facilitates inter-utility transactions that maintain the overall operation of the electrical power distribution grid at a suitable level of performance. For example, when one utility detects that it is nearing the limit of its power generation capacity, it can initiate a request to another utility to shed some its load, and provide the additional capacity to the first utility. A market-based approach can be employed to implement such a transaction. For instance, utility B can offer a price to utility A for additional available power. In turn, utility A can request utility C to shed some of its load, and provide the excess power resulting from the load shedding to utility A at the offered priced, or some lesser price. Utility A can then re-sell the additional power to utility B at the offered price. As an alternative to the utilities communicating directly with one another in this manner, the bartering for available excess power can be conducted through a central facility, e.g. an exchange, with which each of the utilities communicates.

In addition to transactions, individual and interconnected grid data management systems can facilitate other types of intra-utility and inter-utility communication, such as social network and/or message board functionality allowing utility personnel to exchange information on operational best practices, business process improvement, grid and network management policies, regulatory or other policy matters, change management, vendor selection processes, vendor product performance evaluations, pilot results, business case scenarios, use case scenarios, program management experiences, etc. An individual grid data management system can be configured to allow or restrict access to certain information only to certain groups or individuals within a given utility; similarly, interconnected systems can restrict access so that data can be shared only with specific other utilities, specific groups or individuals at specific other utilities, and so on. Any such system can also be configured to provide restricted/controlled access to 3^{rd} parties such as partners, vendors or regulators.

The data that is disseminated by such a network can be utilized by entities other than utilities as well. For example, in the case of plug-in hybrid electric vehicles (PHEVs), each vehicle may provide a unique identification when it is plugged into a charger, to ensure that the proper consumer account is charged. That identification can also be employed for tracking purposes by law enforcement officials. The identifications of stolen PHEVs can be maintained on a list, and can be detected when one of them is plugged into a charger or otherwise detected by the utility smart grid network (e.g., wirelessly between an RF transceiver in the vehicle communicating with a nearby utility meter RF transceiver), after which its location can be conveyed to law enforcement officials via the network of grid data management systems, to enable the vehicle to be retrieved.

As another example, in a Smart City type of environment, information can be conveyed between a location at which a consumer is completing a transaction, and the consumer's home or place of business. For instance, if the consumer purchases frozen goods at a grocery store, as detected by product code scanners and user input of a credit card or customer loyalty number, a signal can be sent to the home area network at the consumer's residence. In response, a command can be issued to cause a food storage freezer to cool down a few additional degrees, to account for the frozen foods that are going to be stored in it.

The Smart City environment provides many other areas of potential integration with utility networks and grid management systems. At the network level, a variety of monitoring, sensing and control equipment may be integrated with the utility LANs, NANs, and WANs previously described, as follows: communications interfaces (whether wireless or wired) within the utility network infrastructure connected to similar interfaces within a variety of municipal or personal devices, including but not limited to streetlights, traffic lights, bridge vibration sensors, vehicle traffic monitoring systems, parking meters, premise security systems, local or large scale renewable (solar, wind, biomass, etc.) generation devices, and so on. The data transmitted through these communications interfaces may include application specific data (e.g., “parking meter has expired”), application specific control (e.g., “turn streetlight on or off”), energy consumption data, or environmental impact data (e.g., “1 million vehicles traverse Highway 1 on a monthly basis, generating an expected carbon footprint of X”). This data and control may flow in its entirety through the utility grid management system, and from there to 3^{rd} party systems (e.g., premise security monitoring systems, consumer facing traffic notification systems). Alternatively, some of the data and control may flow through the utility system (e.g., energy consumption and environmental data), while other data and control may flow directly between 3^{rd} party systems and the end devices (e.g., streetlight control may be done directly by a municipal lighting control system).

While the above examples of smart grid management systems and other management systems were discussed in the context of a single utility having a single smart grid management system, in alternate embodiments a given utility may have one or more smart grid management systems. Additionally, some or all of the other management systems such as generation management systems, transmission management systems, AMI management systems, distribution management systems, or other systems, may be operated, in whole or in part, by other utilities or by other entities.

One example of a smart grid management system is a system for calculating and applying environmental incentives, as discussed below, which may combine information from AMI, generation, transmission, billing systems, ERP systems, CRM systems, outage detection and management systems, regulatory systems, environmental measurement systems, as well as financial systems such as brokerages and exchanges.

Consumers of electrical energy, along with other parties involved in the generation, distribution, transmission, and use of electrical energy may, by law or contract, use, pay, trade or generate incentives which correlate with one or more aspects of environmental impact. Incentives which may be applied to induce a change in the behavior may include a price increase/decrease, at tax or tax credit, a credit (such as a credit as used in a cap and trade system), fees, penalties, loyalty points, or other types of incentives, inducements or financial instruments.

One form of environmental impact is the release of greenhouse gases, such as carbon dioxide (C0₂), into the atmosphere and the concerns that it will lead to undesirable climate change. Incentives which may be applied to induce a change in the behavior may include a price increase/decrease/surcharge/discount, a tax or tax credit, a credit as used in a cap and trade scheme, voluntary credit or avoidance instrument, etc.

Other forms of environmental impacts could involve other pollutants (such as the release of other chemicals such as carbon monoxide, sulfur dioxide, sulfur, salts, potassium, etc.) the release of soot or particulates, the use of a dwindling or limited resource (oil or clean water, etc.), the use of a resource perceived to be undesirable or dangerous (nuclear power, etc.), the use of a resource which has alternative uses (water, bio-fuels, land, etc.), the use of a resource which has an impact on wildlife or aesthetic benefits or negatives (wind, solar, pipelines, etc.), stability or reliability of the energy source (oil, etc.), national security or other concerns (oil, etc.), or any other type of environmental impact which may become a concern.

Calculation and allocation of incentives may involve multiple entities, as multiple entities may either control different aspects of the energy grid or different entities may have different roles in the crediting, accounting, and use of the incentives. For ease of understanding, many of the examples provided herein have a homeowner receiving electrical power from a single utility, and the homeowner either using or receiving carbon credits. As discussed above, other financial incentives may be applied, other environmental factors may be considered (alone, with other environmental considerations, or in conjunction with C0₂ emissions), and other entities may be involved in calculating, allocating, accounting, verifying, using, selling, buying, reporting, financing, or trading incentives.

Calculation of and proper allocation of incentives may be done in real time, near real time, or at a later time. Time association of usage and generation information allows incentives to be applied on any time scale from fractions of a second to hours, days, weeks, months, years, or any portion or combination thereof.

To implement these concepts, a utility may utilize a carbon action engine that receives various types of factors as inputs, and generates one or more outputs based upon those factors. Exemplary inputs to such an engine can include carbon impact and/or carbon price. The carbon price can be determined from factors such as cap & trade regulations, market price, consumption and grid performance. Exemplary outputs of such an engine can be a decision to shut down a particular power-generating facility, e.g. a coal-fired generator, to shed a certain percentage or certain types of loads being supplied with power, and/or to update the price of carbon.

### Interval Reading of Usage Data and Calculating Incentives

Electrical usage data is read and associated with a time during which the electricity was used. Time associated usage data is correlated to time associated energy generation data (specifying carbon impact or the alternate impact) to calculate a carbon credit (or other demand shaping incentive). Time association may be performed by the meter reading the electrical energy, a communications node operating in connection with the electrical energy meter, by other electronic devices in the utility network, or by a back office system which receives electrical energy metering information.

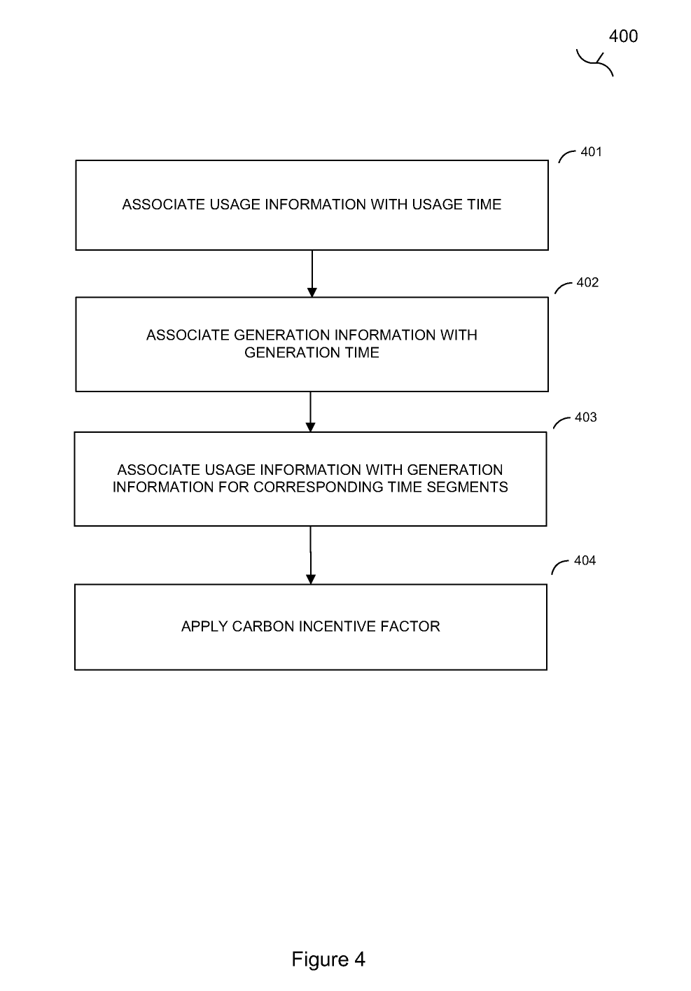

FIG. 4 is a flow chart illustrating the general process 400 of associating usage data and generation data for incentive calculations. At step 401 usage information is associated with a usage time and a given account (typically, the account will correspond to a given facility, person or entity, such as a home owned by a given person, but may correspond to a portion of a facility, multiple facilities, or any combination thereof, as well as corresponding to multiple persons or entities). The usage time may be the time the electrical energy was used, the time the electrical energy was read by, or from, an electric meter, or the time the usage information was received elsewhere. There may be many usage times for a given account, indicating the amount of energy used during multiple usage time segments. In some embodiments, the usage time segments are significantly shorter in duration than the billing cycle for the electrical energy delivered to a given account, allowing for great detail on the usage characteristics of electricity by the account. In one exemplary embodiment, the usage time segments can be on an hourly basis. In another embodiment, the usage time intervals might be related to the frequency with which different sources of energy generation are switched into and out of the utility grid.

Usage information may be recorded by individual devices, or may be derived by a separate device. For example, in normal operation a meter may simply record whole-house consumption. But at certain times, the meter may be put into a mode wherein it samples consumption on much finer-grained timing (e.g., 1 sample per second), with individual devices turned on and off, and the consumption and electrical profile of those devices thus derived, for later use.

Individual devices may thus be identified by their load profiles, or via explicit authentication (e.g., using certificates based on Public Key Infrastructure, or other secure identification). Identifying devices, securely or otherwise, allows the system to adjust the carbon credit/debit accumulation of individual devices based on legal, regulatory or societal policies. These adjustments may result in policy-based penalties, subsidies or waivers being granted to individual devices based on device type, time of day/year, owner, location, or many other possible criteria. For example, an electrical wheelchair may be granted a subsidy or waiver when compared to a plasma TV; a plasma TV in a hospital may be granted a subsidy or waiver when compared to one in a private residence; subsidies or waivers may be granted to devices authenticated to be owned by low income or elderly users, etc.

At step 402 energy generation information is associated with a generation time. The generation information may include the type of generation, the amount of electricity generated, the amount of energy generated above a predefined level (such as base load generation), and/or the facility(or facilities) or entity(or entities) which generated the electricity. The generation time may be the time the electrical energy was generated, the time the electrical energy generation was read by, or from, a measuring device, or the time the generation information was received elsewhere. There may be many generation times for a given account, indicating the amount of energy generated during multiple generation time segments.

At step 403 the usage information is associated with generation information for the corresponding time segments to determine, for the given account, the generation sources of their electrical energy usage, and the relative contributions of the generation sources per time segment. At step 404 a carbon impact factor is applied to the relative contributions of the generation sources per time segment to calculate a carbon impact per time segment. The carbon impact per time segment may be used to calculate a total carbon impact, as well as one or more incentives which may be applied to the given account corresponding to the carbon impact (carbon incentives may also be calculated per time segment information, with or without the total carbon impact). The following examples illustrate applications of these concepts:

### Example 1

An electrical usage meter associated with a home is read at regular intervals using a utility network. Each reading includes the time of the reading, the amount of energy used by the home, the change in the amount of energy since the last reading, and identifying information which allows the home and the account to be identified. One particular reading shows 12 kwh used in a one hour period, from 2:15 pm to 3:15 pm on a given day. The usage information is transmitted to a back office system operated by the utility which supplies the home with electrical power.

A system of monitoring generation notes the amount of electrical energy generated at a given time and the type of generation used to generate the electrical energy. If the electrical energy is generated from more than one source, the respective contributions of the different sources are noted and recorded. At the time period from 2:15 pm to 3:15 pm on the given day, the electrical energy was generated using 50% coal, 30% nuclear, 18% gas fired, and 2% through wind.

A carbon credit use is calculated for the 12 kwh using the generation percentage and also using the carbon factor associated with each generation type. The carbon factors for the generation factors, or credit factors, used are: 1 cr./kwh coal, 0.1 cr./kwh nuclear, 0.5 cr./kwh gas fired, and −0.2 cr./kwh for wind. Thus, the home using 12 kwh from 2:15 pm to 3:15 pm on the given day used 7.392 carbon credits.

### Example 2

An electrical usage meter associated with a home is read at regular intervals using a utility network. The readings include the time of the reading, the amount of energy used by the home, the change in the amount of energy since the last reading, and identifying information which allows the home and the account to be identified. One particular reading shows 12 kwh used in a one hour period, from 2:15 pm to 3:15 pm on a given day. The usage information is transmitted to a back office system operated by the utility which supplies the home with electrical power.

A system of monitoring generation notes the amount of electrical energy generated at a given time and the type of generation used to generate the electrical energy. If the electrical energy is generated from more than one source, the respective contributions of the different sources are noted and recorded. At the time period from 2:15 pm to 3:15 pm on the given day, the electrical energy was generated using 50% coal, 30% nuclear, 18% gas fired, and 2% through wind.

A carbon surcharge is calculated for the 12 kwh using the generation percentage and also using the carbon factor associated with each generation type. The carbon factors for the generation factors used are: 0.2 $/kwh coal, 0.04 $/kwh nuclear, 0.1 $/kwh gas fired, and −0.05 $/kwh for wind. Thus, the home using 12 kwh from 2:15 pm to 3:15 pm on the given day, is assessed a carbon surcharge of $1.55. The standard pricing per kwh at the given time is $0.10 per kwh, resulting in a base electricity charge of $1.20. The total bill the consumer receives for the one hour of electricity usage is $2.75.

### Example 3

An electrical usage meter associated with a home is read at regular intervals using a utility network. The reading is performed in response to a communications node associated with the meter receiving a read command (the read command being received through a wireless utility network). The communications node, after reading the meter, responds to the read command and transmits the read information, through the utility network, to a back office system. The response to the read command includes the time of the reading, the amount of energy used by the home, the change in the amount of energy since the last reading, and identifying information which allows the home and the account to be identified. A series of readings over multiple hours on a given day are: 2:00 pm read 21420 kwh, 2:30 pm read 21490 kwh, 3:00 pm read 21535 kwh, 3:30 pm read 21585 kwh; 4:00 pm read 21590 kwh, which shows 170 kwh used in a two hour period, from 2:00 pm to 4:00 pm on a given day. The usage information is transmitted to a back office system operated by the utility which supplies the home with electrical power.

A system of monitoring generation notes the amount of electrical energy generated at a given time and the type of generation used to generate the electrical energy. If the electrical energy is generated from more than one source, the respective contributions of the different sources are noted and recorded. At the time period from 1:00 pm to 4:30 pm on the given day, the electrical energy was generated using 50% coal, 30% nuclear, 18% gas fired, and 2% through wind.

A carbon credit use is calculated for the 170 kwh using the generation percentage and also using the carbon factor associated with each generation type. The carbon factors for the generation factors used are: 1 cr./kwh coal, 0.5 cr./kwh nuclear, 0.4 cr./kwh gas fired, and 0 cr./kwh for wind. Thus, the home using 170 kwh from 2:00 pm to 4:00 pm on the given day used 122.74 carbon credits.

While the above examples calculated environmental incentives in the form of carbon credits associated with a home, other facilities or other devices or equipment could also have their usage monitored and could have an environmental incentives calculated and applied to one or more accounts. Examples of other devices could include, without limitation, plug-in electric hybrid cars (PHEV), other vehicles, electrical powered devices, industrial equipment, etc. Additionally, the account to which the environmental incentives are applied need not be the owner of the vehicle, but could be another entity which uses (such as renter of a car), finances, operates, or has some other relationship with the facility or device.

### Batch Reading Usage Data and Calculating Incentives

Electrical usage data is read. The usage data is time stamped in increments by the meter/NIC to associate the usage data with a time during which the electricity was used. Time associated usage data is correlated to time associated energy generation data (specifying carbon impact or the alternate impact) to calculate a carbon credit (or other demand shaping incentive).

### Example 4

An electrical usage meter associated with a home is read in batch form using an AMI network. The readings include multiple time intervals, the amount of energy used by the home in the time intervals, the overall change in the amount of energy since the last reading, and identifying information which allows the home and the account to be identified. A communication device and meter of the AMI network perform the interval readings and store the interval readings until the information is transmitted through the AMI network to the back office system. One particular reading includes a time interval which shows 12 kwh used in a one hour period, from 2:15 pm to 3:15 pm, on a given day. The usage information is transmitted to a back office system operated by the utility which supplies the home with electrical power.

A system of monitoring generation notes the amount of electrical energy generated at a given time and the type of generation used to generate the electrical energy. If the electrical energy is generated from more than one source, the respective contributions of the different sources are noted and recorded. At the time period from 2:15 pm to 3:15 pm on the given day, the electrical energy was generated using 50% coal, 30% nuclear, 18% gas fired, and 2% through wind.

A carbon credit use is calculated for the 12 kwh using the generation percentage and also using the carbon factor associated with each generation type. The carbon factors for the generation factors used are: 1 cr./kwh coal, 0.5 cr./kwh nuclear, 0.4 cr./kwh gas fired, and 0 cr./kwh for wind. Thus, the home using 12 kwh from 2:15 pm to 3:15 pm on the given day used 8.66 carbon credits.

### Calculating and Allocating Incentives for Green Generation by Account Holders

A user/account holder who has a certified green generation method (wind, solar, hydro, etc.) receives carbon credits in its account for supplying power back to the grid (in addition to, or in place of, being paid for the power being supplied). The rate of carbon credits may be impacted by generation type (e.g. wind gets more than hydro), actual carbon offset (e.g. greater credits when displacing carbon intensive generation and lower credits/none when displacing clean generation), or other factors, such as per capita consumption, e.g. a credit for being off the grid and thereby reducing overall demand.

### Example 5

A homeowner has installed solar panels on the roof of a home. During summer months, the solar panels generate more power than the home consumes. In July, the home uses 1200 kwh, but the solar panels generate 1450 kwh. Thus, the homeowner sold 250 kwh back to the grid. However, in the winter months the home consumes more power than the solar panels are able to generate. In January, the home used 2100 kwh, while the solar panels generated 1100 kwh, resulting in net use from the grid of 1000 kwh.

Calculation of carbon credits takes into account the power generated by the solar panels. In January, calculation of the carbon credits yielded 80 credits used by the homeowner. Also, the homeowner received 65 credits from the solar panel generation, yielding a net consumption/use of only 15 carbon credits. In July, when the home provided power to the grid rather than taking power from the grid, the homeowner received a net of 15 credits.

The amount of energy produced by the solar panel may be measured and reported by the solar panel (or other generating source), by a device which monitors the generating source, by comparing the usage of the facility to the draw from the grid, to infer the power supplied by the generating source, or by other processes and/or devices.

### Calculating and Allocating Incentives for Green Generation to Associated Account Holders

An associated account, such as a utility or a financial institution who has financed a green generation project gets associated credits. Thus, a utility can get credits if many of its customers put up solar panels. These credits can be of the same type as the customers' credits, e.g. carbon credits, or of a different type, e.g. marketing currency in place of carbon credits. As with primary account calculation, the rate for carbon credits may be impacted by generation type (wind gets more than hydro), actual carbon offset (greater credits when displacing carbon intensive generation and lower credits/none when displacing clean generation), etc.

### Example 6

A homeowner has installed solar panels on the roof of a home. This was done with a loan from bank ABC. During summer months, the solar panels generate more power than the home consumes. In July, the home uses 120 kwh, but the solar panels generate 145 kwh. Thus, the homeowner sold back to the grid 25 kwh, which was purchased by electric utility BCD. However, in the winter months the home consumes more power than the solar panels are able to generate. In January, the home used 210 kwh, while the solar panels generated 110 kwh, resulting in net use from the grid of 100 kwh (supplied by the same utility, BCD).

Calculation of carbon credits takes into account the power generated by the solar panels, the party which financed the solar panels, and the utility which purchased power from the solar panels. In January, calculation of the carbon credits yielded 80 credits used by the homeowner. Also, the homeowner received 65 credits from the solar panel generation, yielding a net consumption/use of only 15 carbon credits. The utility and the bank both receive carbon credits based on the avoided carbon release by generating with the solar panel. The Bank and the Utility each receive 5 credits based on the avoided carbon generation. In July, when the home provided power to the grid rather than taking power from the grid, the homeowner received a net of 15 credits. The bank and the utility also received carbon credits in July from the generation by the homeowner's solar panel. As the avoided carbon release was lower, due to the homeowners' lower overall use, the initial carbon credits for the Bank and the Utility is 3 credits each. An additional bonus of carbon credits is given to both the bank and the utility of 2 credits each, as the homeowner's electrical usage resulted in no net carbon release. Additionally, the utility receives an extra 4 credits for purchasing carbon-free power from the homeowner.

### Calculating and Allocating Incentives to Associated Account Holders

An associated account, such as a utility, may get associated credits according to various conditions. Thus, a utility can get credits (same type or a different type) if its per-user carbon impact declines (utility may release more carbon, but as the population it serves increases, they are incentivized to grow generation capability as clean as possible), if it meets or exceeds projected targets (shifts demand so as to reduce emissions), etc.

### Example 7

A utility has 1000 customers, which it supplies with an average of 12 MW per year. Base load generation typically involves 30% hydroelectric, 2 wind, and 68% coal. During peak demand times generation is accomplished by 15% hydroelectric, 1 wind, and 49% coal and 35% natural gas.

A utility customer 21-0786 who received 100 kwh of energy at a given time, when the composition of generation sources is 25% hydroelectric, 2 wind, and 67% coal and 6% natural gas, may use 11 carbon credits. The utility, supplying the electrical energy to customer 21-0786, also uses 11 carbon credits.

Over the period of one year customer 21-0786 has an allocation of 4000 carbon credits. Over that year customer 21-0786 used 3840 carbon credits, leaving 160 carbon credits in a carbon credit account associated with customer 21-0786. The utility, supplying the electrical energy to customer 21-0786, also has 4000 as the supplier to customer 21-0786, and uses 3840 carbon credits supplying customer 21-0786. Thus, the utility has 160 unused credits associated with supplying electricity to customer 21-0786. The utility may use these credits in supplying electricity to other customers, trade or sell the credits, or save the credits for future use.

In the foregoing examples, the allocated demand-shaping incentives, such as carbon credits, are based upon the type of facility that generated the electricity being used. Various methods can be employed to calculate the carbon credits. As one example, the carbon credits can be calculated according to actual measured carbon release from the facility for a given unit of energy during a specified time that is associated with usage data. In another example, the carbon credit can be based upon historical carbon release per energy unit for a particular type of generation facility.

Other factors besides generation type can also be utilized. For instance, if a new user begins to consume energy, or a prior user increases his/her rate of consumption, the resulting increase in demand causes a marginal carbon impact. This marginal impact resulting from the increased demand can be assessed to the new or increasing user, while other users remain at the carbon credit rate that was being applied prior to the increased demand. Alternatively, the new or increasing user can have the aggregate carbon impact for generating the additional energy, rather than just the marginal increment, assessed, while the other users remain at the rate that was in effect prior to the increase.

The allocated credits and/or applicable rate can be associated with a device or account, rather than the location at which the electricity is consumed. For example, the owner of a PHEV may connect his/her vehicle to a plug at a friend's house while visiting. In that case, the credits are assessed to the account of the vehicle owner at that account's rate, rather than to the account for the friend's house.

In another variation that is based upon accounts, the credits can be assessed in accordance with the number of consumers associated with the account, and/or the type of account, e.g. residential, business, industrial, public, etc.

The price that is charged for the electricity itself could be dependent upon the type of account. For example, a user who elects to set up a carbon credit account could be given a more favorable rate, or even a flat monthly charge, for consumed electricity, in comparison with another user who does not have such an account.

### Purchasing and Selling of Environmental Incentives

An account associated with a customer of a utility is allocated carbon credits, as due by regulation, law or contract. The account holders, who may be individual homeowners or others who participate in the generation, delivery or use of electrical energy, may use the accounts to purchase, sell or trade credits or other incentives. In the event an account holder has credits of a different type, for example credits awarded by region or associated with a given facility, the account holder may trade credits to dispose of credits which are not needed and obtain credits which are needed. Account holders may request or respond to a trade, specifying the type and amount of incentives they seek to trade. Alternatively, the account holders may sell incentives of the type they do not need and purchase credits of the type they do need. The account holder may specify that the purchase order shall not be given until the sale is complete, or may specify the purchase is to occur by a specified time (such as a time by which credits may be needed).

The marketplace or clearinghouse for individual account holders to trade incentives may be provided by an individual utility's grid management system, a separate system within the utility exchanging data with its grid management system, or by a 3^{rd} party system external to the utility (e.g., a bank or other financial institution) exchanging data with the utility systems. Marketplaces may also be restricted to groups of utilities wishing to trade only with each other, by arranging only specific interactions between their grid management systems, between their internal marketplace systems, or by agreement with 3^{rd} party providers.

### Example 8

A customer of utility A is a homeowner and receives 2500 carbon credits per year associated with the ownership of the home serviced by utility A in region A, which are allocated in the homeowner's account. As the homeowner uses credits, through the consumption of electrical energy supplied by the utility, the credit balance in the account of the homeowner changes to reflect the consumption of credits. The homeowner may access the account and may choose to sell or trade credits. The homeowner also owns a second home, which is serviced by utility B in region B, and receives 1800 carbon credits per year associated with the ownership of the home serviced by utility B, which are allocated in the homeowner's account. Given that utility A and utility B are under different regulatory regimes, the credits the homeowner has in connection with utility A can't be used directly for consumption of electricity with utility B, and vice versa.

The homeowner is using more than the allocated carbon credits in connection with the home serviced by utility A while the homeowner is using fewer than its allocated carbon credits in connection with the home serviced by utility B. Accordingly, the homeowner would like to use some of the unused credits associated with utility B in connection with utility A. While this is not directly possible, the homeowner could trade B region credits with a party seeking B region credits in exchange for A region credits, or the homeowner could sell some B region credits and purchase A region credits. In the event of a difference between cost of the credits sold and the credits purchased, the cash or credit excess may be allocated to an account, or donated to another (a charity or specified person, such as family member). Similarly, a cash or credit shortfall may be supplemented by cash or another incentive from another account (such as a checking account associated with the homeowner).

### Example 9

A customer of utility A is a homeowner and receives 2500 carbon credits per year associated with the ownership of the home serviced by utility A, which are allocated in the homeowner's account. The homeowner also receives 4000 water credits per year, the water being provided by utility B, which are allocated in the homeowner's account. As the homeowner uses credits, through the consumption of electrical energy supplied by utility A or water by utility B, the corresponding credit balance in the account of the homeowner changes to reflect the consumption of the different credits. The homeowner may access the account and may choose to sell or trade credits of either type.

The homeowner is using more carbon credits than those awarded in connection with the home, and using less than the allocated water credits. Accordingly, the homeowner would like to use some of the unused water credits associated with utility B for receiving electricity from utility A. While this is not directly possible, the homeowner could trade utility B water credits with a party seeking B water credits in exchange for A electricity credits, or the homeowner could sell some B water credits and purchase A electricity credits.

### Example 10

A customer of utility C is a small business who uses fewer carbon credits than it is allocated. The monthly allocation of 1750 carbon credits usually results in 200 carbon credits not being used. The small business owner may sell the credits on its own, as excess credits build in the account. However, to simplify matters the small business owner has enrolled in Utility C's auto-sell program, whereby the excess credits are sold without the small business owner needing to initiate each sale. The small business owner has specified that the sale is to take place whenever the account reaches a net balance of 4500 credits or more, and the sale is to be for all credits above 3750, allowing the small business owner to always have a full month of allocation, plus 2000 extra credits to cover emergencies or unexpected high usage.

### Example 11

A customer of utility D is a homeowner who regularly uses more credits than are allocated. The customer is allocated 800 credits per month, but typically needs between 950 and 1170 credits per month. To make up for the shortfall, and avoid penalties imposed by not having enough credits at the time of use, the homeowner sets up a buying program on a carbon credit account with the following purchase rules. Rule 1, purchase carbon credits up to a preset limit (that the homeowner specified) when either the price of credits drops below a preset threshold (specified by the homeowner), or when the price of carbon credits drops more than 10% (also specified by the homeowner). Rule 1 is only to be used in purchases when the account balance is below a threshold specified by the homeowner. Rule 2, purchase carbon credits in the event the account balance drops below a homeowner specified critical threshold, up to a certain amount (set in currency or number of credits). As the homeowner uses electricity the purchasing rules automatically allow the needed carbon credits to be acquired. Also, when electricity use drops such that the carbon credit account is no longer being depleted, the purchasing rules do not result in over purchases as set by the thresholds.

The purchasing, selling, and trading of environmental incentives may also include transfer of incentives between two or more accounts, and may be performed by preset rules.

### Example 12

A customer of utility E is a light industrial business operating multiple facilities. Its monthly carbon credit allotment is 32,000 credits, which are credited to the customer's account at utility E. Typical usage is below the monthly allotment by, on average, 5,000 credits. However, some months the monthly allotment is exceeded by 3,000 or 4,000 credits. The customer typically sells excess credits from a brokerage account held with a financial institution G. To facilitate selling, the customer puts in place carbon credit balance transfer rules with utility E which specify: if the carbon credit account balance at the utility reaches 50,000 credits or more, credits in excess of 40,000 credits are to be transferred to the customer's brokerage account with financial institution G. Additionally, the customer puts in palace balance transfer rules which specify: in the event the balance in the carbon credit account at utility E drops below 4,000 credits, transfer up to 4000 carbon credits from the customer's brokerage account with financial institution G, up to the existing balance of carbon credits in the brokerage account. The customer may also put in place rules for the automated purchase of needed carbon credits in the account with financial institution G, such as purchase up to 4,000 carbon credits in the event the account balance in the brokerage account with financial institution G is insufficient to meet a balance transfer request to the account with utility E, the balance transfer request in response to an expected or occurring shortfall in the account with utility E, and where the purchase price per credit does not exceed a maximum carbon credit purchase price threshold.

### Display and Reporting of Incentive Information

The rate or other information used for calculating incentives credits may be transmitted to one or more devices or computers for display.

### Example 13

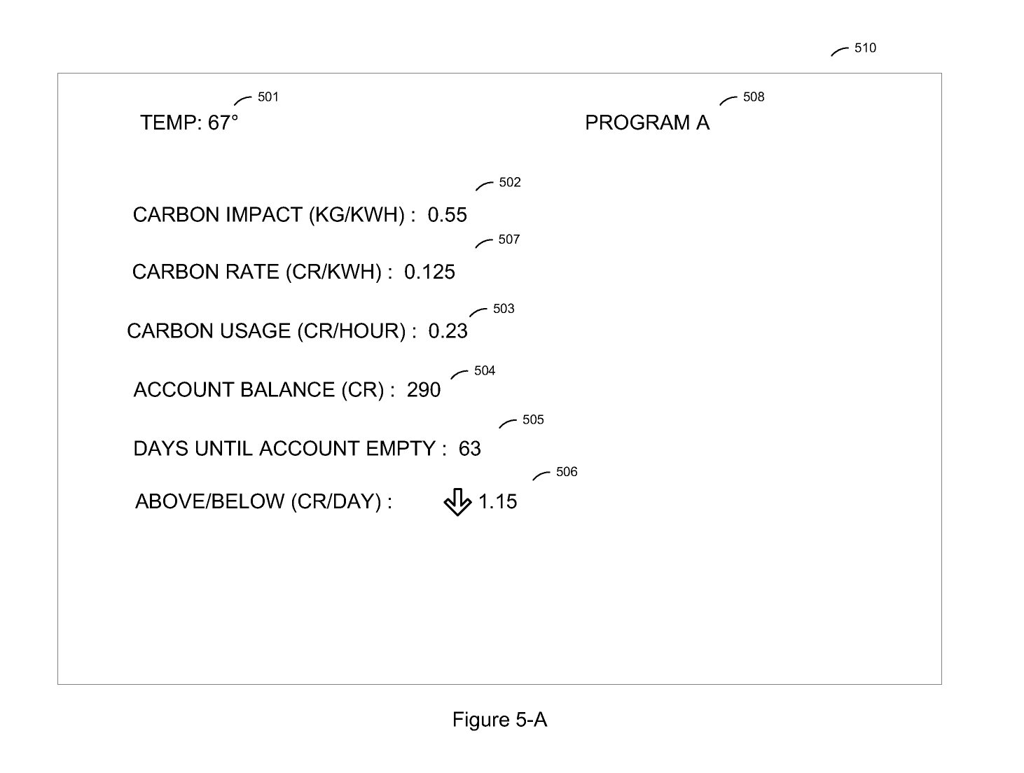

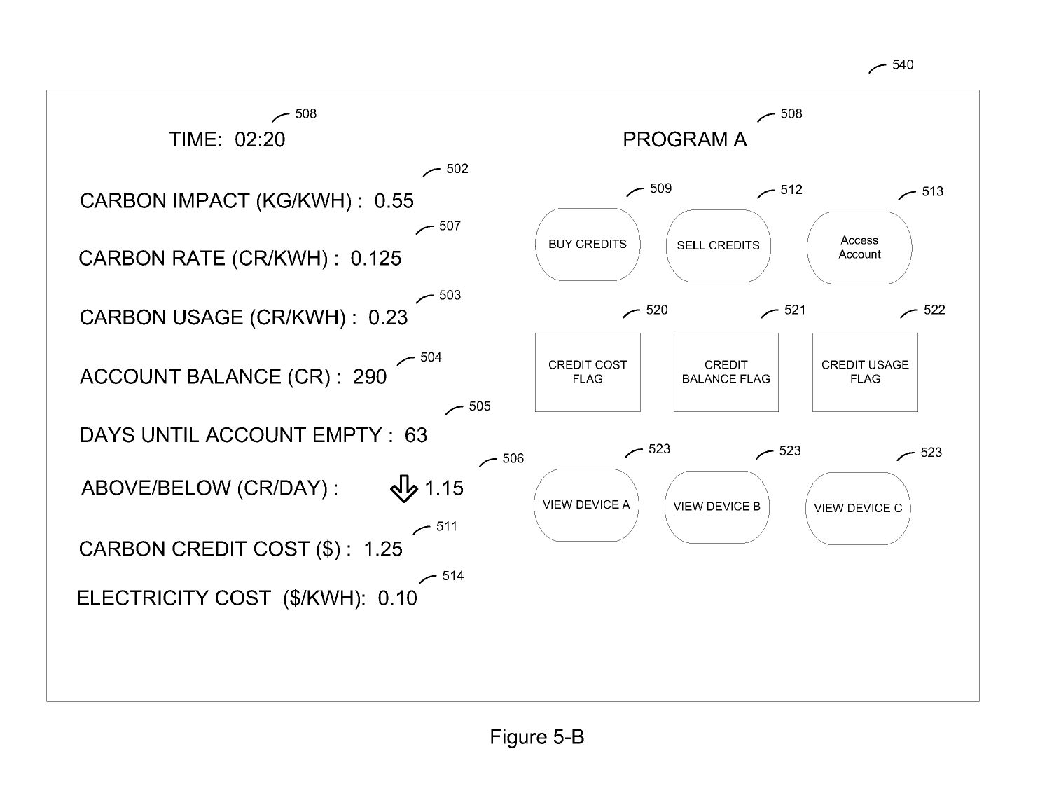

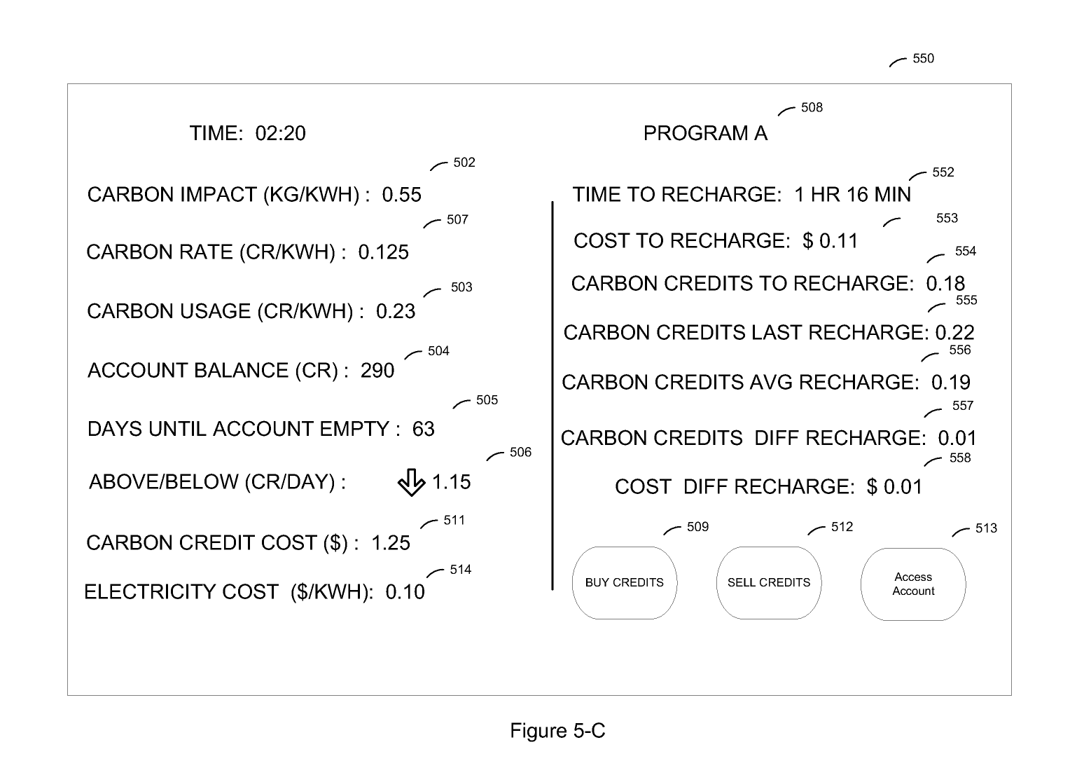

A homeowner has a thermostat which controls the heating in the home (the home is heated using electric heat). As shown in FIG. 5-A, the thermostat has a display which displays the current temperature 501, carbon impact information 502, rate of carbon credit use (or generation, as in the case with green generation) per unit time 503, carbon credit account balance 504, estimate of the time remaining at current (or historical, or estimated) carbon use before the carbon credit account balance is empty (or reaches a threshold) 505, estimate of whether the carbon usage is above or below a given rate of usage (such as the number of carbon credits per day, etc.) 506, and carbon credit rate per unit of energy 507. The rate of carbon use displayed may be the rate of carbon use by the heating system controlled by the thermostat, by the entire home, or by the use of select devices or systems used or metered in connection with the home. Other information may also be displayed, such as the current time, outside temperature, the program or mode the thermostat is set to 508, etc. In the event the homeowner changes the temperature the thermostat is set to, the displayed information may be updated to reflect the new temperature. Additionally, in the event the carbon impact information, or any other information used to calculate or display incentives (or calculate or display environmental impact or cost), the display may update such information as well as information which may be impacted by the change.

### Example 14

A homeowner has a display 540 in the home as shown in FIG. 5-B. The display displays carbon impact information 502, rate of carbon credit use (or generation, as in the case with green generation) 503, carbon credit account balance 504, estimate of the time remaining at current (or historical, or estimated) carbon use before the carbon credit account balance is empty (or reaches a threshold) 505, estimate of whether the carbon usage is above or below a given rate of usage (such as the number of carbon credits per day, etc.) 506, cost of carbon credits 507, generation source information 508, cost of carbon credits 511, and cost of electricity 514. The rate of carbon use displayed may be the rate of carbon use by the heating system controlled by the thermostat, by the entire home, or by the use of select devices or systems used or metered in connection with the home. Other information may also be displayed, such as the current time, outside temperature, the program, menu or mode the display is set to 508, etc. In the event the homeowner changes the temperature the thermostat is set to, the displayed information may be updated to reflect the new temperature. Additionally, in the event the carbon impact information or any other information used to calculate or display incentives (or calculate or display environmental impact or cost) the display may update such information as well as information which may be impacted by the change.

Additionally, the display may also include, either on the display shown or on a menu accessible from the display shown, one or more controls to sell and/or buy carbon credits. A button 509 provides for the buying of carbon credits and a button 511 provides for the selling of carbon credits (or any other environmental incentive). Either or both of the buttons to buy carbon credits or sell carbon credits may transact a preset amount, a displayed amount (which may be generated according to the expected need or lack of need of credits, historical need or lack of need or transaction history, etc.) or an amount to be entered (previously or after selection of the buy carbon credits or sell carbon credits button, respectively). Access account button 513 provides a screen for viewing and interacting with the carbon credit account associated with the homeowner, where the homeowner may view balances, sell, buy, trade, change selling, buying or trading rules or instructions, cancel sell, buy or trade orders not yet completed, and view any other information and/or perform any other actions relating to the account. Credit cost flag 520 displays alerts when the cost of credits changes significantly, or when it reaches a preset threshold (or both). Credit balance flag 521 displays alerts when the carbon credit balance reaches a balance warning level, which may be preset, or may be based upon projects of use at current, historical, or extrapolated rates. View device button 523 may also be included on the display, or accessible through a program or other screen or menu, which allows the particular usage relating to a given device to be displayed, such as a hot water heater, computer, room, or other device or group of sub devices associated with the display (typically, but not necessarily, devices within or associated with the home or facility). Selecting a device or group of devices using view device button may bring up a separate display for the device, or may change the values displayed on display 540 to correspond to the selected device(s). The view device button may be highlighted, or otherwise visually distinguishable, when the displayed values correspond to the selected device(s), or another visual indication may be used to indicate the displayed values correspond to the selected device(s). In the event only some of the displayed values correspond to the selected device(s), the values corresponding to the selected device(s) may be visually distinguished from values not corresponding to the selected device(s), such as by highlighting the values corresponding to the selected device(s), by diminishing values not corresponding to the selected device(s), or by some other indication.

### Example 15

A homeowner has a display 550 in a PHEV as shown in FIG. 5-C. The display displays carbon impact information 502, rate of carbon credit use (or generation, as in the case with green generation) 503, carbon credit account balance 504, estimate of the time remaining at current (or historical, or estimated) carbon use before the carbon credit account balance is empty (or reaches a threshold) 505, estimate of whether the carbon usage is above or below a given rate of usage (such as the number of carbon credits per day, etc.) 506, cost of carbon credits 507, generation source information 508, cost of electricity 514, time to recharge the batteries of the PHEV 552, cost to recharge the PHEV batteries 553, carbon credits needed to recharge the PHEV batteries 554, carbon credits needed to recharge the PHEV batteries on the last recharge 555, carbon credits needed to recharge the PHEV batteries during an average recharge 556, difference between carbon credits needed to recharge the PHEV batteries during an average recharge and the current recharge 557, cost of the difference between carbon credits needed to recharge the PHEV batteries during an average recharge and the current recharge 558, etc. The rate of carbon use displayed may be the rate of carbon use by the recharging of the PHEV's batteries, by the entire home, or by a facility (or account) other than the home where the PHEV is to draw power to recharge the PHEV's batteries.

Additionally, a select account icon or menu maybe displayed, allowing the operator of the PHEV to select the account the PHEV is to draw carbon credits from during a recharge (or select the account that the electricity should be billed from). In the event the carbon impact information or any other information used to calculate or display incentives (or calculate or display environmental impact or cost) changes, the display may update such information as well as information which may be impacted by the change. Additionally, the display may also include, either on the display shown or on a menu accessible from the display shown, one or more controls to sell and/or buy carbon credits. A button 509 provides for the buying of carbon credits and a button 510 provides for the selling of carbon credits (or any other environmental incentive). Either or both of the buttons to buy carbon credits or sell carbon credits may transact a preset amount, a displayed amount (which may be generated according to the expected need or lack of need of credits, historical need or lack of need or transaction history, etc.) or an amount to be entered (previously or after selection of the buy carbon credits or sell carbon credits button, respectively. Access account button 513 provides a screen for viewing and interacting with the carbon credit account associated with the homeowner, the PHEV, the entity owning or leasing the PHEV, etc. Warning flags such as the credit balance flag shown above may also be included on the PHEV display(s).

While the above examples have displays in the home and in a PHEV, displaying environmental incentive information may be presented on any display, and any type of device or facility may include a display for displaying environmental incentive information (along or with other information).

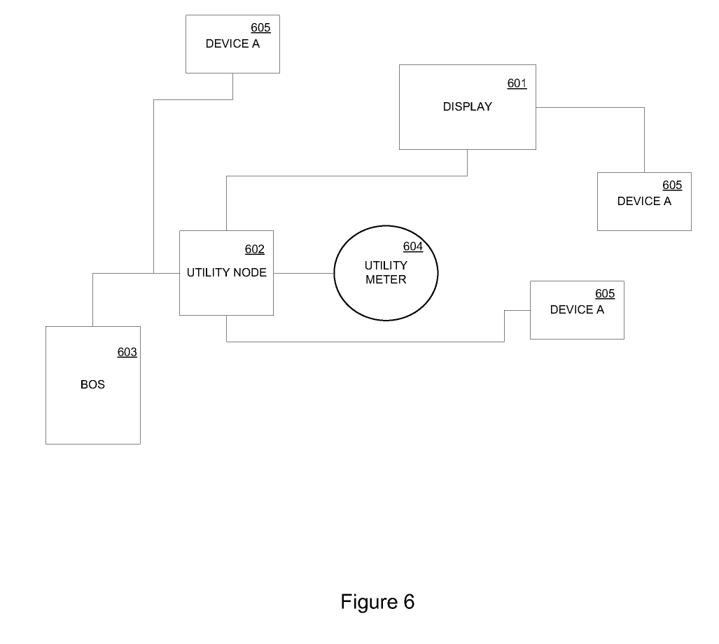

FIG. 6 is a generalized block diagram illustrating the communication between devices associated with a given facility (such as a home or industrial or office site) and a display for that facility. A display 601 may communicate with a utility node 602. The utility node 602 may be in communication with other utility nodes and/or back office systems 603 (directly or indirectly through other communication devices in a communication network such as a utility network) which provide information on energy usage, account information, energy source information, environmental impact information, etc. The display may also communicate with the back office systems 603 through a public communication network (for example, the Internet) or a private third-party network. The utility node may communicate with one or more metering devices such as an electric utility meter 604. Communication between the utility node and the metering device may be direct (wired) or wireless. Also, the communication node may be integrated with, or part of, one or more metering devices such as the electric utility meter. Other devices 605 within the facility may also communicate with the display 601, the utility node 602, the electric utility meter 604, and/or back office systems 603.

### Example 16

A homeowner has a display in the home; the display is a stand-alone display, mounted as an information center for the home. In one mode the display displays carbon impact information, rate of carbon credit use, carbon credit account balance, estimate of the time remaining at current carbon use before the carbon credit account balance is empty, estimate of whether the carbon usage is above or below a given rate of usage, cost of carbon credits, generation source information, rate of consumption by multiple devices (and the contributions of those devices to the overall carbon credit usage by the home), the status of several devices within the home (whether they are on/off), the status and usage of a PHEV. The display collects information on the devices and the PHEV through a home area network (HAN) by communicating with the utility node through a HAN interface of the utility node, the utility node communicating with the PHEV and the other devices. At least one of the other devices communicates with the utility node through the HAN, and the utility node reports information from the device to the display.

The utility node also communicates through a wireless mesh utility network with back office systems to receive information on generation, carbon impact, account balances, and/or other information. Some of the information to be displayed is calculated by the utility node. One such displayed information item calculated by the utility node is the carbon credits per hour used by the home and by certain devices. The utility node receives the carbon impact information, consumed energy information (for both the home and the devices), calculates the rate of carbon usage, and transmits the rate of carbon usage to the display using the HAN. The homeowner has set warning limits and thresholds, through the display, to alert the homeowner when certain conditions arise. The conditions set by the homeowner are: if current credit usage exceeds X, if credit balance drops below 800 credits, if the time remaining on the credit balance drops below 15 days of average usage, if the time remaining on the credit balance drops below 5 days of current usage, if the price of carbon credits on a carbon credit exchange drops below Y, and if the price of carbon credits on a carbon credit exchange rises above Z. In the event one or more warning/notification conditions are satisfied, the display may either display an indication that there is a warning/notification, and may also include specifics of the warning/notification (or the specifics of the warning/notification may be accessed through the display).

While the above example had the rate of carbon credit usage computed by the utility node, alternate embodiments could have such a calculation performed by another computing device, such as the display (which may have computing capacity) or by a back office system. Additionally, one or more devices within the facility may perform some or all calculations necessary for information to be displayed. Notification that one or more warning/notification conditions are satisfied may also include, or be limited to, an audible alert, messages sent via email, text message, placing a call, other visual indication (on the display or other devices) or any other form of notification or indication. Such information can also be conveyed by reproducing a current image of the display, or portions thereof, on a personal web site so that it can be viewed by the consumer when away from home.

While the example displays above are separate devices in the home, alternate embodiments may have the information displayed on a computer, for example by accessing a web site (such as the account of the homeowner at either a utility or at the account at a incentive trading institution such as a brokerage).

Whether on a device or on a web site, the incentive information may be further annotated with information of value either to the individual consumer or to the provider of the system. For example, individual devices or web sites may provide social networking capability for end users, comparing their energy behavior with peer groups identified either explicitly (the user joining the group), or implicitly (the user vis a vis other customers of the same utility, or by demographics, location, habits, interests and so on). As another example, displays or web pages associated with individual users or groups of users may be annotated with energy related tips, advertising for product or service offerings, and so on. To support such annotation, the utility grid management system may share information regarding users, and in particular their energy consumption in aggregate or by device, to 3^{rd} parties wishing to target their offerings to such users. As one example, a utility may help identify users with old or inefficient HVAC systems, and providers of more efficient HVAC systems may be allowed to serve ads targeting these customers, either disjoint from or potentially in conjunction with incentive programs offered by the utility or other entities (e.g., state or federal tax rebates).

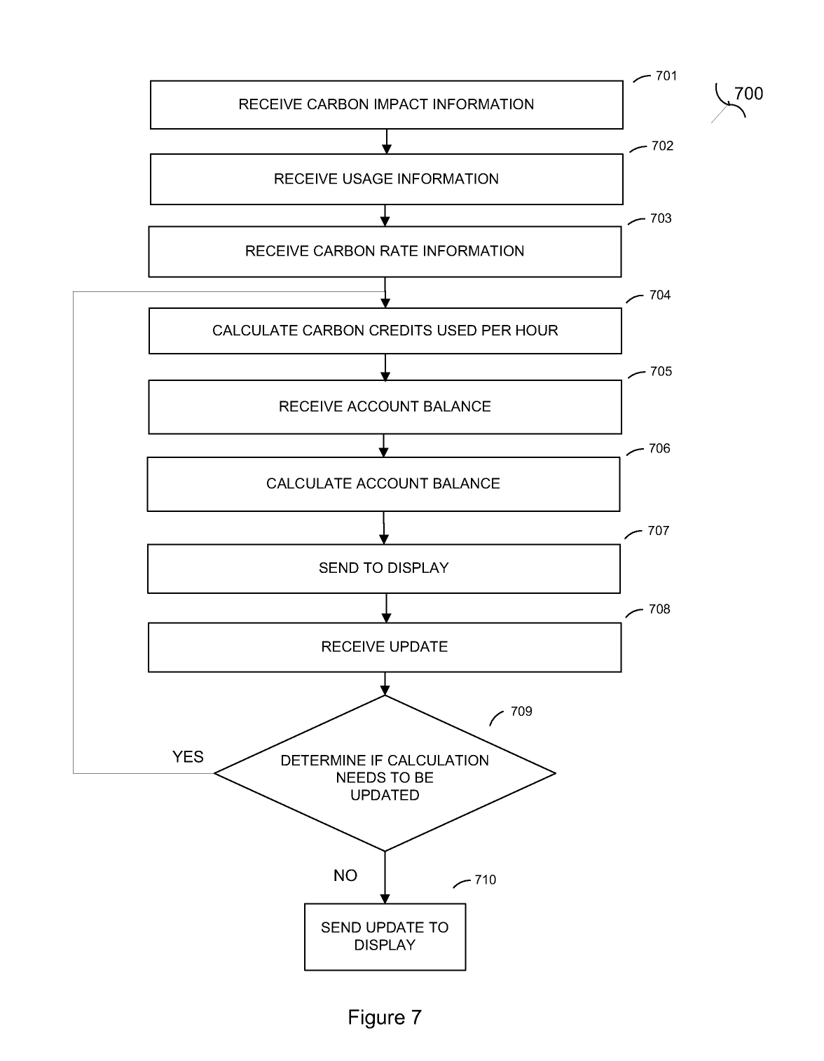

FIG. 7 is a flow chart of a process for updating and communicating with a display associated with displaying environmental incentive information based upon the consumption of a commodity supplied by a utility, such as electricity. For the purposes of illustration, process 700 is described below in connection with a stand alone display used to display carbon credit information connected with the use of electricity in a residential home. At step 701 carbon impact information is received. At step 702 usage information is received. At step 703 carbon credit rate information is received. At step 704 the carbon credit used is calculated (for example, carbon credits may be calculated as a rate, for example carbon credits used per hour, per day, etc). At step 705 account balance information is received. At step 706 account balance information is calculated (for example, the time remaining before the account reaches a threshold, or the credits expected to remain after a given event is completed, such as the charging of the PHEV, etc.). At step 707 received and/or calculated information is transmitted to one or more displays. At step 708 update information is received. The update may include any, or all, information displayed or used in calculating information. One or more updates may be received, including some or all of the information received in the update. At step 709 the received update information is used to determine whether calculated information needs to be updated. If the determination is that one or more calculations needs to be updated, then the process returns to step 704 to perform the update calculations. If the determination at step 709 is that update calculations are not necessary, then process 700 proceeds to step 710. Alternatively, the determination at step 709 need not be performed, and the update is information is used to update the calculations at step 704. At step 710 the information to be displayed is sent to the display. The information to be displayed may include any, or all, received and/or calculated information.

The display of such information relating to carbon credits, and notifications based upon such information, make the consumer aware of the effect of different types of energy-consumption conditions, and may incentivize the consumer to behave in a more responsible manner. In addition to shaping consumer behavior, the carbon credit information can be used to automatically control various devices to result in more energy-efficient operations. For example, a home area network can be provided with a controller that receives the carbon credit information, and adjusts the operating parameters of one or more devices in accordance with such information. If the account balance for carbon credits falls below a threshold level, a command can be sent to certain appliances to cause them to reduce their rate of energy consumption. For instance, the temperature of a refrigerator or freezer can be raised a few degrees, or a thermostat can be set to a lower temperature in winter (or higher temperature in summer), without waiting for the consumer to take any action. If the account balance continues to fall below a second, lower threshold, the refrigerator and/or freezer can be cycled on and off periodically, to reduce demand further. The various appliances and other electronic devices can be prioritized, so that these types of consumption-reducing activities are carried out in a progressive manner in dependence upon the account balance. The priority can be assigned on the basis of the type or criticality of the devices, e.g. a refrigerator is more critical than a dishwasher, and therefore would have its operation adjusted later in the progression. Alternatively, the priority could be assigned based upon the energy efficiency of the devices, so that the operation of a lower-efficiency device is adjusted sooner than a more efficient device. As another approach, priorities can be dynamically assigned through collaboration among the devices. For instance, it can be based on historical information, e.g., a device has not performed a given task for a long period of time, and therefore should be given higher priority than those which have performed an important task more recently. Other conditions for collaborative prioritization could be the condition of a device, e.g., a very low charge on a PHEV, or expected need, such as the charging of a PHEV by a certain time in the morning to accommodate daily commuting. Based upon their relative priorities, devices can power down or reduce load to accommodate the needs of higher-priority devices. This collaborative prioritization can be accomplished via direct communication among the devices, or through a central controller.

Similar types of control can be effected in response to other carbon credit factors, such as rate of usage, and/or current carbon credit rate.

Knowledge of the efficiency ratings of the appliances and other electronic devices can also be used as an incentivizing factor when determining the carbon credit rate that is applied to a particular premises. For example, a baseline efficiency rating can be established for each type of device. For each device in a premises whose efficiency is below that baseline, the carbon credit rate applied to that premises can be increased by a certain percentage, whereas for each device whose efficiency is above the baseline, the carbon credit rate is decreased by a percentage.

The invention has been described with reference to particular embodiments. However, it will be readily apparent to those skilled in the art that it is possible to embody the invention in specific forms other than those embodiments described above. For example, the preceding examples have been presented in the context of carbon credits as one form of environmental incentive. The applicability to other types of incentives should be readily apparent. For instance, if there is a social preference for employing regenerative forms of energy sources, such as wind, solar or hydroelectric, over other types such as nuclear power, an appropriate form of credit or other incentive could be applied in accordance with the foregoing principles and examples.

Thus, the preferred embodiment are merely illustrative and should not be considered restrictive in any way. The scope of the invention is given by the appended claims, rather than the preceding description, and all variations and equivalents which fall within the range of the claims are intended to be embraced therein.

The embodiments presented herein combine sub-systems and functionalities to illustrate the presently preferred embodiments. Alternative embodiments may include fewer or additional sub-systems, processes, or functional aspects, or may be used with other sub-systems, processes, or functional aspects, depending on the desired implementation. Various features and advantages of the present invention are set forth in the following claims.

1.-37. (canceled)

38. A method, comprising:
receiving information relating to usage of electrical energy at a site;
associating the received electrical energy usage information with a usage interval;
retrieving carbon impact information that corresponds to the usage interval;
calculating a value related to carbon credits, based on the retrieved carbon impact information of the usage interval and the received electrical energy usage information associated with the usage interval; and
displaying an indication of the calculated value at said site.

39. The method of claim 38, wherein said value comprises a rate at which carbon credits are being consumed based upon the usage of electrical energy.

40. The method of claim 39, wherein said indication comprises the calculated value.

41. The method of claim 39, wherein said indication comprises an indicator whether the calculated value is greater that a predetermined threshold value.

42. The method of claim 39, wherein said indication comprises an indicator whether the calculated value is within a predetermined range.

43. The method of claim 38, wherein said value comprises an amount of carbon credits that have been consumed, based upon the usage of electrical energy.

44. The method of claim 43, wherein said indication comprises the amount of carbon credits remaining in an account.

45. The method of claim 43, wherein said indication comprises an estimated period of time before carbon credits in an account will be depleted.

46. The method of claim 38, wherein said indication comprises a cost value associated with calculated carbon credits.

47. A method, comprising:
receiving information relating to usage of electrical energy at a site;
associating the received electrical energy usage information with a usage interval;
retrieving carbon impact information that corresponds to the usage interval;
calculating a value related to carbon credits, based on the retrieved carbon impact information of the usage interval and the received electrical energy usage information associated with the usage interval;
displaying an indication of the calculated value at said site; and
controlling the operation of at least one electricity-consuming device at said site, based upon said calculated value.

48. The method of claim 47, wherein said device is controlled on the basis of historical data relating to periods of relatively high and low calculated values.

49. The method of claim 47, wherein said calculated value comprises a rate at which carbon credits are being consumed, and said device is selectively deactivated when said rate exceeds a predetermined value.

50. The method of claim 47, wherein said calculated value comprises an amount of carbon credits that have been consumed, and said device is selectively deactivated when said amount exceeds a predetermined value.

51. The method of claim 47, wherein said calculated value comprises an amount of carbon credits remaining in an account, and said device is selectively deactivated when said amount falls below a predetermined value.

52. The method of claim 47, wherein said calculated value comprises a cost at which carbon credits can be purchased, and said device is selectively deactivated when said rate exceeds a predetermined value.

53. The method of claim 47, wherein said value comprises a rate at which carbon credits are being consumed based upon the usage of electrical energy.

54. The method of claim 47, wherein said value comprises an amount of carbon credits that have been consumed, based upon the usage of electrical energy.

55. The method of claim 54, wherein said indication comprises the amount of carbon credits remaining in an account.

56. The method of claim 54, wherein said indication comprises an estimated period of time before carbon credits in an account will be depleted.

57. The method of claim 47, wherein said indication comprises a cost value associated with calculated carbon credits.
